(19) United States
(12) Patent Application Publication
(10) Pub. No.: US 2002/0135454 A1
(43) Pub. Date: Sep. 26, 2002

(54) Temperature sensor

(76) Inventors: Shunji Ichida, Tokyo (JP); Tohru Okamoto, Akita (JP); Matsuo Zama, Akita (JP)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/104,507

(22) Filed: Mar. 21, 2002

(30) Foreign Application Priority Data
Mar. 22, 2001 (JP) 082421/2001
Mar. 22, 2001 (JP) 082424/2001
Jul. 17, 2001 (JP) 217217/2001

(51) Int. Cl. H01C 3/04

(52) U.S. Cl. 338/25

(57) ABSTRACT

A temperature sensor includes a temperature detection element, a band-like flexible printed wiring board, and a thin, elongated protection pipe. The temperature detection element has a temperature detection metal foil resistor. The temperature detection element is attached to a distal end of the flexible printed wiring board. The protection pipe accommodates the flexible printed wiring board and the temperature detection element.

### BACKGROUND OF THE INVENTION

The present invention relates to a temperature sensor using a metal resistor.

In the semiconductor market, as the micromachine technique advances recently, an increase in wafer diameter and reduction in feature size and cost of the pattern progress more and more. Currently, mass production of semiconductor ICs (Integrated Circuits) with a pattern width of 0.13 μm on a wafer with a large diameter of 300 mm progresses rapidly. Assume that a pattern with a pattern width of 0.13 μm is to be formed on a wafer with a diameter of 300 mm and a thermal expansion coefficient of 2.6×10⁻⁶/° C. For example, when a temperature difference of 0.01° C. (10 m° C.) occurs between the center and periphery of the wafer, the pattern width expands or contracts by ±0.0078 μm (=300×10⁻³×2.6×10⁻⁶×0.01). More specifically, with a temperature difference of ±10 m° C., the pattern width varies by 0.13 μm±6% (=0.0078/013), causing a decrease in yield. For this reason, in a semiconductor manufacturing apparatus, the temperature must be controlled with higher precision so the wafer diameter can be increased and the feature size of the pattern can be decreased.

When a temperature precision of ±10 m° C. is required, temperature control must be performed by one order of magnitude (1/10) or less, i.e., ±1 m° C. Accordingly, a temperature adjusting unit must control by 1 m° C., and a higher-level temperature sensor, i.e., with a high sensitivity of 1 m° C., high reliability, high response speed, and low power consumption is required. In current temperature control, a platinum wire resistor type temperature sensor with a good stability and reliability is usually used as the temperature sensor.

FIG. 10 shows a conventional platinum wire resistor type temperature sensor used in a semiconductor manufacturing apparatus and the like. In a platinum wire resistor type temperature sensor 1, a Pt resistance wire 2 with a large resistance-temperature coefficient is wound on a thin, elongated glass pipe 3, and is accommodated in a protection pipe 4. The Pt resistance wire 2 has a wire diameter of about 0.01 mm and a resistance of about 100 Ω. The glass pipe 3 is made of glass or a ceramic material, and has a diameter of about 0.5 mm to 1 mm and a length of about 5 mm to 10 mm. The protection pipe 4 is made of stainless steel (SUS304, SUS316, or the like), and has an outer diameter of about 1.5 mm to 2 mm.

An insulating tube 5 for insulating the Pt resistance wire 2 and protection pipe 4 from each other is made of polyimide or the like and has an outer diameter of about 1 mm to 1.5 mm and a length of about 10 mm. Relay connection wires 6 connect the Pt resistance wire 2 and external lead lines 7 to each other. A metal pipe 8 holds the external lead lines 7 and is filled with a filler (adhesive) 9 made of an epoxy resin or the like. A stainless-steel interweaved wire member 10 protects the external lead lines 7. A glass cloth insulating tube 11 prevents short circuit of connection ends 12 of the relay connection wires 6 and external lead lines 7. Insulating tubes 13 made of polyimide or the like prevent short circuit of the relay connection wires 6.

The protection pipe 4 and metal pipe 8 are connected to each other by charging the filler 9. More specifically, the filler 9 seals the protection pipe 4 and fixes the relay connection wires 6 and external lead lines 7 simultaneously. The relay connection wires 6 are formed of Ag (silver) wires or the like with a diameter of 0.1 mm to 0.3 mm and a length of about 15 mm, and are connected to the Pt resistance wire 2 through spot welding portions 14, and are connected to the external lead lines 7 with solder.

As the protection pipe 4 has a small inner diameter, the external lead lines 7 with an ordinary thickness cannot be inserted in it to directly connect it to the Pt resistance wire 2. Hence, the two thin relay connection wires 6 are connected to the Pt resistance wire 2, and the relay connection wires 6 are extended from the protection pipe 4 and connected to the external lead lines 7.

Usually, three external lead lines 7 are used. When high-precision measurement is to be performed, four external lead lines 7 are used. When three lead lines are used (3-wire cable type), one lead line is connected to one end of the Pt resistance wire 2 and two lead lines are connected to the other end of the Pt resistance wire 2. In this case, measurement is performed in the following manner. First, the resistance is measured with the lead lines at the two ends of the Pt resistance wire 2, and the resistances of the two lead lines are measured. The resistances of the two lead lines are subtracted from the first resistance to obtain the resistance of the Pt resistance wire 2 itself. In this case, measurement is performed on the assumption that the resistance of one remaining lead line and ½ the resistance of the two lead lines coincide, i.e., that all lead lines have the same resistance. As the Pt resistance wire 2 has a low resistance of 100 Ω, an error occurs in temperature measurement.

When four lead lines are used (4-wire cable type), the two lead lines are connected to the ends of the Pt resistance wire 2 as current lines, and the two remaining lead lines are connected to the ends of the Pt resistance wire 2 as signal detection lines. In this case, a current is supplied with the two current lead lines, and the voltage of the Pt resistance wire 2 is measured with the two signal detection lead lines. More specifically, according to the 4-wire cable type, the current is supplied from a certain lead line, and the voltage across the two ends of the Pt resistance wire 2 is measured with the remaining lead lines. Hence, only the resistance of the Pt resistance wire 2 can be measured at high precision regardless of the resistances of the lead lines.

The conventional platinum wire resistor type temperature sensor 1 shown in FIG. 10 uses the relay connection wires 6. As the resistances of the relay connection wires 6 are added to that of the Pt resistance wire 2 and the temperature characteristics of the relay connection wires 6 are added to those of the Pt resistance wire 2, an error occurs when compared to a case wherein only the resistance of the Pt resistance wire 2 is measured.

As described above, since the conventional platinum wire resistor type temperature sensor 1 is of the wire-winding type and has a low resistance, problems in the following items (i) to (vi) arise.

(i) The resistance of the Pt resistance wire 2 is usually as low as about 100 Ω. To measure a small temperature change, a large current must be supplied. In this case, thermal influence caused by self heat generation inevitably increases, and high-precision measurement cannot be performed.

For example, with a resistor with a resistance of 100 Ω, assume that when the temperature changes by 1° C., the resistance changes by about 0.4 Ω, and that a current of 1 mA has been supplied at this time. In this case, the signal voltage changes by 0.4 mV. The power consumption in this case is 10⁻⁴ W (W=RI²=100×10⁻³×10⁻³). If temperature control of 1 m° C. is to be performed by using such a temperature sensor 1 in the semiconductor manufacturing apparatus, the heat value (power consumption) of the sensor itself is large to disorder control. When a pattern with a pattern width of about 0.1 μm is to be formed on the large-diameter wafer described above by photoetching, the heat generated by the sensor itself may fluctuate the temperature of the temperature sensor or disturb temperature control, and sufficient control cannot be performed.

As the conventional platinum wire resistor type temperature sensor 1 described above is of the wire-winding type, the diameter of the Pt resistance wire 2 cannot be decreased to 0.01 mm (a lower limit of a thin wire that allows operation) or less, and the resistance cannot be increased. This is due to the following reason. To increase the resistance, a longer Pt resistance wire 2 must be wound on the glass pipe 3. Then, the shape of the temperature detection element increases inevitably, and the response against a temperature change is sacrificed. Winding operation requires close attention, leading to difficult operation.

(ii) The temperature characteristics (resistance) of the relay connection wires 6 are added to the temperature characteristics and resistance of the Pt temperature detection element. This causes fluctuation in characteristics and decreases the temperature precision.

(iii) Since the insulating tube 5 is used to insulate the Pt resistance wire 2 and protection pipe 4 from each other, the outer diameter of the protection pipe 4 further increases, and the sensitivity (response) against a temperature change decreases.

(iv) Since the protection pipe 4 and metal pipe 8 are connected to each other through the filler 9, the structure is weak against the outer environment, particularly humidity, and cannot be used in a liquid. Due to a humidity or temperature change, if the filler 9 is peeled or cracking occurs in the connecting portion of the relay connection wires 6 and external lead lines 7 or that of the protection pipe 4 and metal pipe 8, the resistance of the Pt resistance wire 2 drifts, and a measurement error tends to occur.

(v) Since the Pt resistance wire 2 and relay connection wires 6 are connected to each other through the spot welding portions 14, spot welding operation is difficult to perform and the connection reliability decreases. More specifically, when the Pt resistance wire 2 becomes considerably thin, its terminal tends to remain to project from glass coating, thus causing defective insulation easily. The thinner the Pt resistance wire 2, the more easily the Pt resistance wire 2 at the welded portion tends to be disconnected, thus causing defective conduction easily.

(iv) No member supports the insulating tube 5, and it is not certain what portion of the Pt resistance wire 2 or glass pipe 3 comes into contact with what portion of the protection pipe 4. Hence, heat transfer from the protection pipe 4 varies to lead to variations in temperature response, thus interfering with high-precision control.

### SUMMARY OF THE INVENTION

It is an object of the present invention to provide a temperature sensor in which both size reduction and an increase in resistance are achieved simultaneously to decrease power consumption and to improve the sensitivity.

It is another object of the present invention to provide a temperature sensor with improved measurement precision.

It is still another object of the present invention to provide a temperature sensor in which manufacturing facilitation, reliability, vibration resistance, and the like are improved.

It is still another object of the present invention to provide a temperature sensor in which variations in temperature response are decreased.

In order to achieve the above objects, according to the present invention, there is provided a temperature sensor comprising a temperature detection element having a temperature detection metal foil resistor, a band-like flexible printed wiring board with the temperature detection element being attached to a distal end thereof, and a thin, elongated protection pipe for accommodating the flexible printed wiring board and the temperature detection element.

### BRIEF DESCRIPTION OF THE DRAWINGS

FIG. 1A is a sectional view of a temperature sensor according to the first embodiment of the present invention;

FIG. 1B is an enlarged sectional view of the element unit shown in FIG. 1A;

FIG. 2 is a plan view of the temperature detection element shown in FIGS. 1A and 1B;

FIG. 3 is a plan view of the flexible printed wiring board shown in FIGS. 1A and 1B;

FIG. 4 is a view showing how bump bonding is performed;

FIG. 5A is a view showing the connection state of the flexible printed wiring board and external lead lines;

FIG. 5B is a view showing an example in which the flexible printed wiring board is bent to have elasticity;

FIGS. 6A and 6B are sectional views, respectively, showing the main parts of other examples of a hermetic component;

FIGS. 7A and 7B are side and plan views, respectively, showing a case wherein an Ni foil resistor and circuit pattern are connected to each other through bonding wires;

FIG. 8 is a plan view of a temperature detection element showing a resistance pattern according to the second embodiment of the present invention;

FIGS. 9A to 9C are plan views showing other examples of the resistance pattern shown in FIG. 8; and

FIG. 10 is a sectional view of a conventional Pt wire resistor type temperature sensor.

### DESCRIPTION OF THE PREFERRED EMBODIMENTS

The present invention will be described in detail with reference to the accompanying drawings.

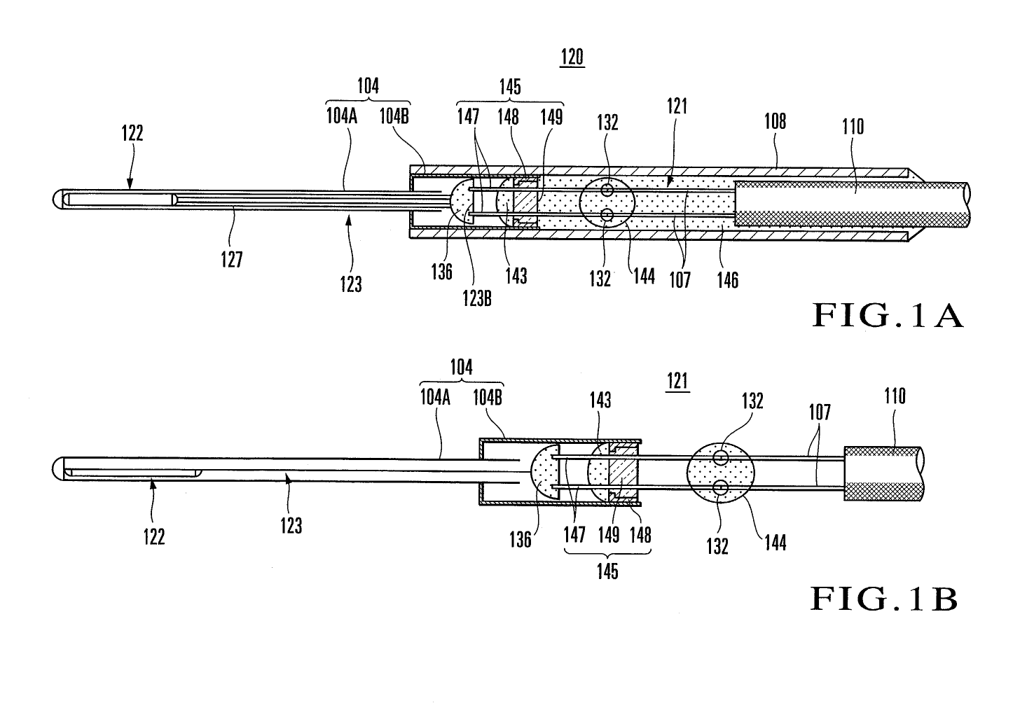

FIG. 1A shows a temperature sensor according to one embodiment of the present invention. Referring to FIG. 1A, a temperature sensor 120 is comprised of an element unit 121 and a metal pipe 108 incorporating the element unit 121.

As shown in FIGS. 1A and 1B, the element unit 121 is comprised of a temperature detection element 122, a band-like flexible printed wiring board 123 with the temperature detection element 122 being attached at its distal end, an elongated protection pipe 104 for accommodating the temperature detection element 122 and flexible printed wiring board 123, external lead lines 107, and a hermetic component 145 for electrically connecting the external lead lines 107 and flexible printed wiring board 123 to each other and hermetically sealing the protection pipe 104.

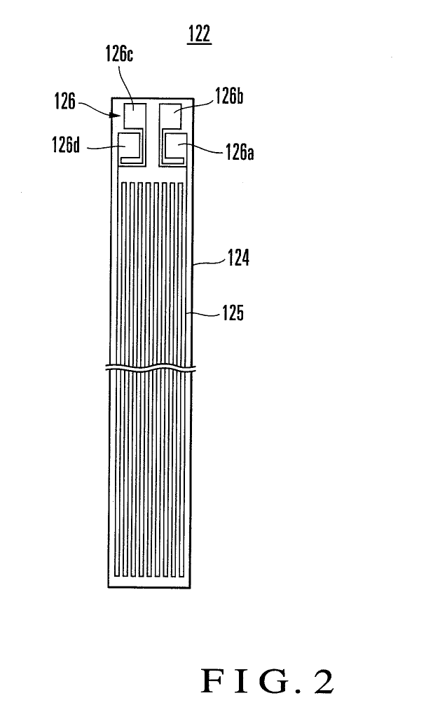

As shown in FIG. 2, the temperature detection element 122 is comprised of a ceramic substrate 124 made of alumina or the like, and an Ni foil resistor 125 serving as a metal foil resistor formed on the surface of the ceramic substrate 124. The ceramic substrate 124 is formed into a thin, elongated sheet with a width of 0.7 mm to 1.0 mm, a length of 5 mm to 10 mm, and a thickness of about 0.4 mm. The Ni foil resistor 125 is formed on the ceramic substrate 124, together with a pad portion 126 formed of four pads 126a to 126d, by known photoetching. The ceramic substrate 124 is not limited to a thin elongated sheet-like substrate.

The Ni foil resistor 125 is formed in the following manner. Ni with a large resistance-temperature coefficient is adhered to the surface of the ceramic substrate 124, and is etched into a predetermined pattern, thus forming the Ni foil resistor 125 with a repeatedly bent zigzag shape. The two pads 126a and 126b, and the two pads 126c and 126d are formed on the two ends of the Ni foil resistor 125 in a parallel manner. The Ni foil resistor 125 covered with an insulating film (not shown) has a thickness of 1 μm to 3 μm, a width of about 10 μm, and a resistance of about 1,000 Ω. The pad portion 126 is formed on one end of the ceramic substrate 124. The insulating film is not necessarily formed.

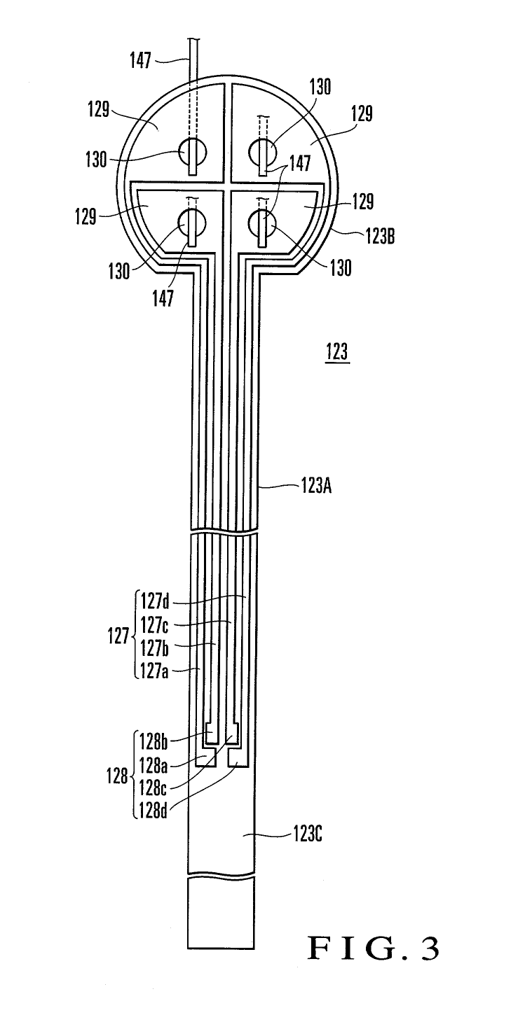

As shown in FIG. 3, the flexible printed wiring board 123 is comprised of a main body 123A formed of polyimide or the like into an elongated band-like shape with substantially the same width as that of the ceramic substrate 124 and having an appropriate elasticity, and a circular (or square) connecting portion 123B integrally formed at the proximal end of the main body 123A. A circuit pattern portion 127 is formed on the surface of the main body 123A, and the pad portion 128 is formed at the distal end of the circuit pattern portion 127 to correspond to the pad portion 126 of the Ni foil resistor 125. The circuit pattern portion 127 is formed of four parallel circuit patterns 127a to 127d, and the pad portion 128 is formed of four pads.

More specifically, the pads 128a and 128b of the circuit patterns 127a and 127b respectively correspond to the pads 126a and 126b of the Ni foil resistor 125. The pads 128c and 128d of the circuit patterns 127c and 127d respectively correspond to the pads 126c and 126d of the Ni foil resistor 125. The distal end of the flexible printed wiring board 123 integrally has a cover portion 123C which covers that portion on the temperature detection element 122 where the Ni foil resistor 125 is formed. This prevents the Ni foil resistor 125 from coming into contact with the inner wall surface of the protection pipe 104 to cause short circuit.

In the circuit pattern portion 127, the two outer circuit patterns 127a and 127d are used as current lines for supplying a current to the metal foil resistance line 125. The two inner circuit patterns 127b and 127c are used as signal detection lines for detecting a voltage when power is supplied to the Ni foil resistor 125. Land portions 129 are formed on the proximal end of the circuit pattern portion 127. The land portions 129 are formed on the surface of the connecting portion 123B, and respectively have insertion holes 130, at their centers, where terminals 147 of the hermetic component 145 are to be inserted. The circuit pattern portion 127, pad portion 128, and land portions 129 are formed simultaneously by printed wiring board forming technique. After that, only the circuit pattern portion 127 is covered by an insulating film.

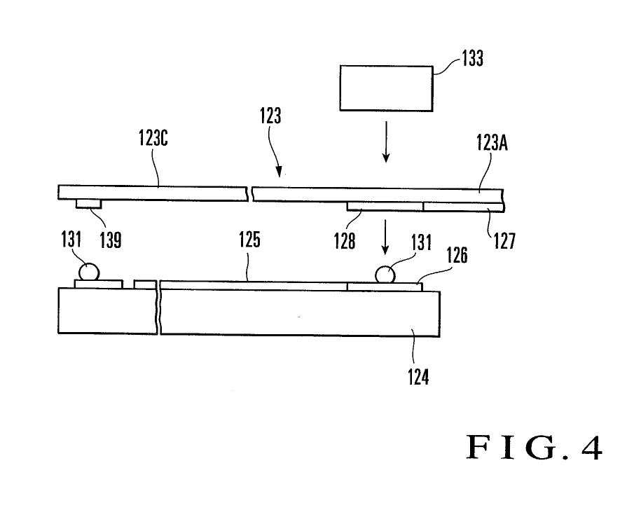

The circuit pattern portion 127 of the flexible printed wiring board 123 and the Ni foil resistor 125 of the temperature detection element 122 described above are connected to each other by bump bonding. To perform bonding, as shown in FIG. 4, solder pieces 131 such as solder balls are placed on the pad portion 126 of the Ni foil resistor 125. Then, with the flexible printed wiring board 123 being turned over, pads 128a to 128d are placed on the temperature detection element 122 to correspond to the pads 126a to 126d. Subsequently, a high-temperature heat sink 133 is urged against the lower surface of the flexible printed wiring board 123 to melt the solder pieces 131, thus fusing the pad portions 126 and 128 to each other. Since the pad portions 126 and 128 are formed by photoetching, they can be positioned accurately. Since bump bonding has a large bonding area, its reliability is high and thus can be automated.

In bump bonding, another pad portion 139 may also be formed on the distal end of the cover portion 123C of the flexible printed wiring board 123. In this case, the pad portion 139 is bump-bonded to pad portions, formed independently of the Ni foil resistor 125, through solder pieces 131. Then, the cover portion 123C will not be rolled up. The Ni foil resistor 125 can thus be covered reliably, and short circuit of the Ni foil resistor 125 with the protection pipe 104 can be prevented. Even when the pad portion 139 or the pad portion of the Ni foil resistor 125 is not formed, the same effect can be obtained by only covering the resistor.

The external lead lines 107 consist of four external lead lines 107 (only two are shown in FIGS. 1A and 1B). Of the four external lead lines 107, one pair of two external lead lines 107 serve as current lines and the remaining pair of external lead lines 107 serve as signal detection lines. These four external lead lines 107 are respectively connected to the terminals 147 of the hermetic component 145. The external lead lines 107 and terminals 147 are connected through solder portions 132, and their connecting portions are sealed and reinforced by a synthetic resin 144. The synthetic resin 144 is not always needed.

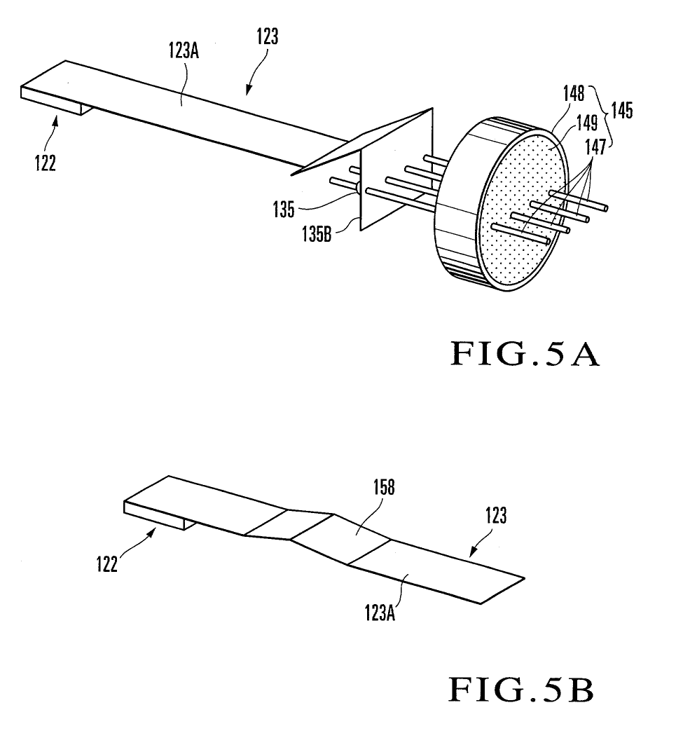

As shown in FIG. 5A, the hermetic component 145 is formed of four terminals (lead lines) 147, a metal ring 148 formed of Kovar or the like into a cylindrical shape with two open ends, and a sealing glass member 149 for sealing the terminals 147 in the metal ring 148. To fabricate the hermetic component 145 with this arrangement, the sealing glass member 149 formed by powder molding with pressing is put in the metal ring 148 mounted on a sealing mold. The terminals 147 are inserted in insertion holes formed in the sealing glass member 149, and the sealing glass member 149 is fused by heating in a burning furnace, thereby sealing the terminals 147 and metal ring 148 integrally. The hermetic component 145 is fabricated in this manner.

The pin-like terminals 147 made of Kovar or the like extend through the metal ring 148. As shown in FIG. 3, the front ends of the terminals 147 are connected to the land portions 129 of the circuit pattern portion 127, while the rear ends thereof are connected to the external lead lines 107, as described above. The terminals 147 and land portions 129 are connected by inserting the distal ends of the terminals 147 through the small holes 130 of the land portions 129 and connecting them with the solder 135 (FIG. 5A). Alternatively, these connecting portions may be sealed with a synthetic resin 135. A synthetic resin 143 is potted to the surface of the hermetic component 145 in order to reinforce the terminals 147.

The hermetic component 145 is directly pressed into the protection pipe 104. If the outer surface of the metal ring 148 is plated with solder or gold in advance, the protection pipe 104 can be sealed with a higher hermeticity, and the sealing reliability can be increased.

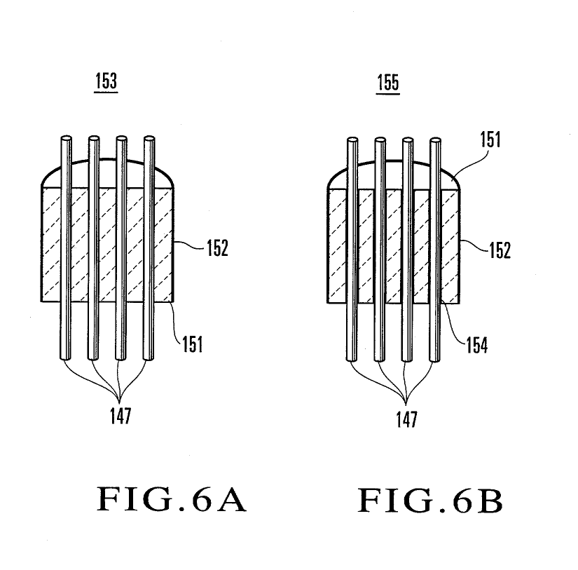

FIGS. 6A and 6B show other examples of the hermetic component.

A hermetic component 153 shown in FIG. 6A is comprised of terminals 147, a ceramic stem 151, and a metal film 152 metallizing the outer surface of the ceramic stem 151. The hermetic component 153 with this arrangement is fabricated by calcinating the ceramic stem 151 having insertion holes, inserting the terminals 147 in the insertion holes, and calcining the resultant structure. According to another fabricating method, terminals 147 may be inserted in insertion holes of a calcined ceramic stem 151, and ceramic cement may be charged in the insertion holes. Alternatively, terminals 147 coated with ceramic cement may be inserted in insertion holes, and the ceramic cement may be calcined.

The metal film 152 to metallize the outer surface of the ceramic stem 151 is formed by applying a metallizing liquid, obtained by mixing metal powder such as molybdenum or tungsten in a solvent, on the outer surface of the ceramic stem 151, and calcining the ceramic stem 151. Since molybdenum or tungsten has a thermal expansion coefficient close to that of the ceramic stem 151, it can reliably metallize the surface of the ceramic stem 151 without cracking. If the metallized surface is plated with nickel, copper, gold, or the like which is easy to braze, the protection pipe 104 can be sealed with a higher hermeticity, and the sealing reliability can be increased. Namely, although metallizing of the metal film 152 is performed to further increase the reliability, the hermeticity can be ensured without the metal film 152.

A hermetic component 155 shown in FIG. 6B is comprised of terminals 147, a ceramic stem 151, metal films 152 for metallizing the outer surfaces of the terminals 147 and ceramic stem 151, and metal films 154 for metallizing the outer surfaces of the terminals 147. The hermetic component 155 with this arrangement is fabricated in the following manner. The ceramic stem 151 with insertion holes is calcined, and the inner surfaces of the insertion holes are metallized with the metal films 154. Subsequently, the terminals 147 are inserted in the insertion holes and brazed with a brazing material such as solder, tin, lead, or the like, thereby fabricating the hermetic component 155. The metal film 152 to coat the outer surface of the ceramic stem 151 is formed in the same manner as that described above. The metal films 154 are formed by applying glass, mixed with metal powder such as molybdenum, tungsten, palladium, or silver, on the inner surfaces of the insertion holes, and calcining the resultant structure. In the same manner as described above, the hermeticity can be ensured without the metal films 152.

The protection pipe 104 shown in FIGS. 1A and 1B is formed of an elongated small-diameter pipe 104A with an open proximal end and closed distal end, and a large-diameter pipe 104B fitted on the proximal end of the small-diameter pipe 104A. The small-diameter pipe 104A made of stainless steel (SUS304, SUS316, or the like) has an outer diameter of 1.0 mm to 1.2 mm, an inner diameter of 0.9 mm to 1.0 mm, and a length of about 20 mm to 30 mm, and incorporates the temperature detection element 122 and flexible printed wiring board 123. The outer diameter of the large-diameter pipe 104B is substantially equal to the inner diameter of the metal pipe 108. The small-diameter pipe 104A and large-diameter pipe 104B are connected to each other by brazing or welding. The large-diameter pipe 104B is hermetically closed as the hermetic component 145 is pressed into its rear end opening, and an inert gas or oil is sealed in it. When the inert gas or oil is to be sealed, it is desirably sealed after pressurization. As the inert gas, argon, nitrogen, dry air, or the like is used. As the oil, silicone oil or the like is used.

In this embodiment, the protection pipe 104 is formed of two members, i.e., the small- and large-diameter pipes 104A and 104B connected to each other by brazing or welding. However, the present invention is not limited to this. A protection pipe integrally having a small-diameter portion corresponding to the small-diameter pipe 104A and a large-diameter portion corresponding to the large-diameter pipe 104B, which are formed by drawing, can naturally be used.

The hermetic component 145 (or 153, 155) may be fixed to the large-diameter pipe 104B by projection welding or brazing, other than press fitting. Projection welding is not preferable as it requires large welding facilities and electrical work. Brazing is not preferable as it requires brazing facilities. In the case of press fitting, only a small handpress need be prepared as facilities, and its operation is simple. When the temperature is to be measured in a not very severe environment, as in a room or dry air, press fitting is sufficient.

The metal pipe 108 is formed of a pipe made of stainless steel (SUS316 or the like) and with two open ends, and has an outer diameter of 4.0 mm, an inner diameter of 3.0 mm, and a length of about 30 mm to 50 mm. The large-diameter pipe 104B is fitted in the front end of the metal pipe 108 by insertion, and a stainless-steel interweaved wire member 110 for protecting the external lead lines 107 is inserted in the rear end thereof. A synthetic resin (thermoset resin) 146 fills and seals the entire interior of the metal pipe 108, i.e., to the position of the hermetic component 145.

To fabricate the temperature sensor 120 with this arrangement, first, the flexible printed wiring board 123 and temperature detection element 122 are bonded to each other by bump bonding. Subsequently, the connecting portion 123B of the flexible printed wiring board 123 is bent, as shown in FIG. 5A, and the terminals 147 are inserted in the insertion holes 130 (FIG. 3) of the land portions 129 and connected with the solder 135. These connecting portions may be further mold-reinforced with a synthetic resin 136 (FIGS. 1A and 1B).

The flexible printed wiring board 123 attached with the temperature detection element 122 is inserted in the protection pipe 104, and the hermetic component 145 is pressed into the large-diameter pipe 104B. At this time, the front end and lower surface of the temperature detection element 122 are urged against the inner wall surface of the small-diameter pipe 104A. This urging is performed by utilizing elasticity of the flexible printed wiring board 123 itself and the restoring force of the bent connecting portion 123B. To further increase the elasticity of the flexible printed wiring board 123, a V-shaped bent portion 158 may be formed at the intermediate portion of the main body 123A, as shown in FIG. 5B. As the bent portion 158 has a force (restoring force) to return to the original shape, it can extend the main body 123A to reliably urge the temperature detection element 122 against the inner wall surface of the protection pipe 104.

If the element unit 121 is fabricated by sealing an inert gas or oil in the protection pipe 104 before sealing the large-diameter pipe 104B with the hermetic component 145, an element unit with a higher reliability and faster response speed can be obtained.

Subsequently, the element unit 121 is inserted in the metal pipe 108 to cause the small-diameter pipe 104A to project from the distal end of the metal pipe 108. The synthetic resin 146 is charged to fill the interior of the metal pipe 108 entirely, to fix the stainless-steel interweaved wire member 110 of the external lead lines 107 connected to the terminals 147. Thus, fabrication of the temperature sensor 120 is ended.

According to the temperature sensor 120 with this structure, since the Ni foil resistor 125 is used, a large strength is not required of the resistor itself when compared to the conventional wire-winding type temperature sensor 1 using the Pt resistance wire 2 (since the Pt resistance wire 2 need not be wound on the glass pipe 3), and a resistor with a large resistance (e.g., about 1,000 Ω) can be formed. Also, the sensor can be fabricated easily and can be downsized. In contrast to this, with the conventional Pt temperature sensor 1, when the resistance is increased, the length of the Pt resistance wire 2 increases to increase the size. Therefore, a resistor wire with a resistance of 1,000 Ω cannot be used.

When the Ni foil resistor 125 is used, since a desired resistance pattern can be formed by photoetching, a resistor with a required resistance can be freely fabricated. In other words, for example, when the thickness of the Ni foil resistor 125 is decreased and the pattern width thereof is decreased, the resistance can be increased (although photoetching has its limitations, they are very small when compared to those of a wire-winding type Pt resistance wire). Thus, a resistor with a resistance of 1,000 Ω can be fabricated on the small ceramic substrate 124. For example, when the thickness of 3 μm is decreased to 2 μm, the resistance can be increased by about 1.5 times. Furthermore, the pattern width can also be decreased from about 10 μm to about 6 μm, so the resistance can further be increased by about 1.5 times. Because of this mutually potentiating effect, the resistance can be increased by 2 times or more (1.5×1.5=2.25).

The Ni foil resistor 125 can be fabricated more easily when compared to the Pt resistance wire, and the temperature detection element 122 itself can be made into an elongated band regardless of the high resistance. Consequently, the diameter of the small-diameter pipe 104A for accommodating such a temperature detection element 122 can be decreased to 1.0 mm or less. As a result, the temperature sensor 120 itself can be downsized. When the protection pipe 104 can be made thin, the heat capacity is decreased, so the response speed with respect to the temperature change of a measurement target can be improved.

Since the Ni foil resistor 125 has a high resistance, the current and heat value are small when compared to those obtained with the conventional Pt temperature sensor. Hence, a small temperature change can be highly precisely detected with a high sensitivity.

Since the interior of the protection pipe 104 is sealed by the hermetic component 145, water or humidity will not enter the protection pipe 104, so the environmental resistance of the temperature sensor 120 can be improved. Therefore, the resistance does not drift, and the stable performance is maintained over a long period of time, and the temperature can be detected highly precisely. Since the hermetic component 145 only need be pressed into the large-diameter pipe 104B, only a simple handpress need be used, and its operation is easy.

Since the inert gas or oil is sealed in the protection pipe 104, the stability and thermal conductivity of the Ni foil resistor 125 can be increased. In this case, if the inert gas or oil is sealed in a pressurized state, the response speed with respect to a temperature change can further be increased. When the hermetic component 145 is to be pressed into the large-diameter pipe 104B, only a small handpress need be used as facilities. If operation is performed in a gas chamber where the inert gas is supplied, the inert gas can be sealed simultaneously with the press-in operation, and the workability can be further improved.

The four circuit patterns 127a to 127d formed on the flexible printed wiring board 123, the external lead lines 107, and the Ni foil resistor 125 are connected to each other through the terminals 147 of the hermetic component 145. Therefore, despite the decrease in diameter of the protection pipe 104, the 4-wire cable type temperature sensor 120 can be realized. Hence, the voltage across the two terminals of the Ni foil resistor 125 can be measured, and high-precision temperature measurement can be performed without being adversely affected by the resistances of the external lead lines 107, circuit patterns 127a to 127d, and terminals 147.

Since the distal end face and lower surface of the temperature detection element 122 are urged against the inner wall surface of the small-diameter pipe 104A of the protection pipe 104 by the elasticity of the flexible printed wiring board 123, heat is conducted well from the protection pipe 104 to the temperature detection element 122, and variations in temperature response decrease. Since the temperature sensor 120 does not move upon application of vibration or shock, it maintains a stable resistance, and can perform accurate temperature measurement.

Since the Ni foil resistor 125 and circuit pattern portion 127 are bump-bonded to each other, the bonding operation is easy when compared to ordinary bonding by means of soldering. Thus, the bonding operation can be automated, improving the bonding reliability.

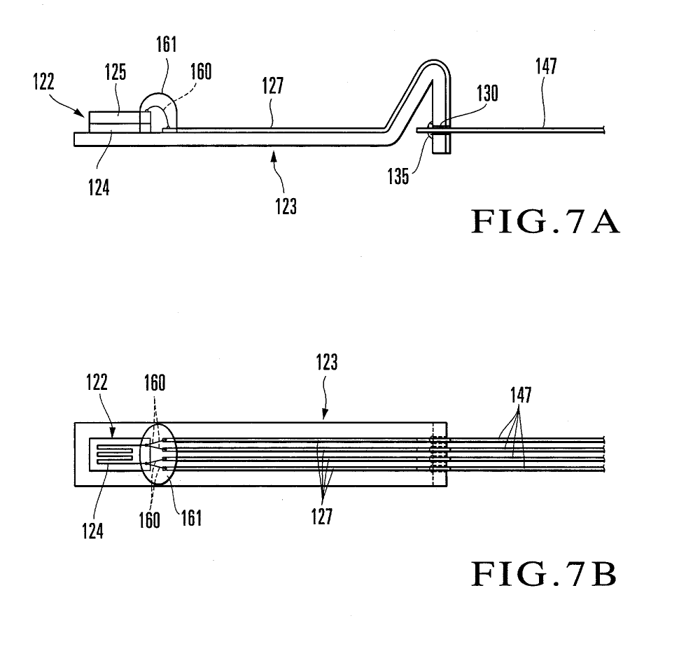

FIGS. 7A and 7B show another example of the bonding structure of the temperature detection element and flexible printed wiring board. In this example, an Ni foil resistor 125 of a temperature detection element 122 and a circuit pattern portion 127 of a flexible printed wiring board 123 are connected to each other through bonding wires 160 in place of bump bonding. These connecting portions are sealed and reinforced by a synthetic resin 161.

In this case, as the method of sealing with the synthetic resin 161, it is preferable that the temperature detection element 122 be sealed entirely in order to improve the environmental characteristics. Then, however, distortion occurs due to the difference in thermal expansion coefficient between the synthetic resin 161 and ceramic substrate 124 or Ni foil resistor 125, leading to a drift in resistance of the Ni foil resistor 125. Therefore, this sealing method is not preferable. Hence, according to this example, distortion is prevented and drift in resistance of the Ni foil resistor 125 is prevented by sealing only the bonding portions with the synthetic resin 161.

In the first embodiment described above, the Ni foil resistor is bent back in the longitudinal direction of the substrate. A case wherein the Ni foil resistor is bent back in the widthwise direction of the substrate will be described.

To fabricate the temperature detection element described above, particularly, in order to increase the resistance of the Ni foil resistor, the Ni foil resistor must be formed long by repeatedly bending back its pattern on the substrate. In this case, the bending-back direction can be the longitudinal direction or widthwise direction of the substrate. A pattern formed by “bending back in the longitudinal direction” refers to a pattern in which the linear portions of the resistance pattern are parallel to the longitudinal direction of the substrate and the curved portions (bent-back portions) thereof line up in the widthwise direction of the substrate. A pattern formed by “bending back in the widthwise direction” refers to a pattern in which the linear portions of the resistance pattern are perpendicular to the longitudinal direction of the substrate and the curved portions thereof line up in the longitudinal direction. As in the first embodiment, when the Ni foil resistor is bent back in the longitudinal direction of the substrate, the number of curved portions is small when compared to a case wherein the Ni foil resistor is bent back in the widthwise direction. Thus, the resistance increases.

In this manner, when an Ni foil resistor is formed on an elongated substrate, the bend-back direction of the resistance pattern adversely affects the measurement precision. This is due to the following reason. As the thermal expansion coefficients of the ceramic substrate and Ni foil resistor are different from each other, the resistance of the Ni foil resistor drifts during the manufacture or use, thus causing a temperature error. More specifically, since the thermal expansion coefficients of the Ni foil resistor and ceramic substrate are respectively about 130×10⁻⁷/° C. and about 70×10⁻⁷/° C., a larger distortion occurs in the longitudinal direction of the elongated ceramic substrate. For example, when the ratio of the length to the width of the ceramic substrate is 10:1, the ratio in size of distortion is also 10:1. If the Ni foil resistor is bent back in the longitudinal direction of the ceramic substrate, the resistance of the Ni foil resistor drifts, causing a temperature error.

Furthermore, if the resistance pattern is bent back in the longitudinal direction of the ceramic substrate, tens of linear portions of the resistance pattern run in the longitudinal direction of the ceramic substrate. In this case, the distortion with respect to the resistance is accumulated in a number corresponding to the number of linear portions to appear as a large resistance drift, causing a large temperature error. The applied distortion is gradually relaxed as time elapses. Hence, the temperature resistance gradually drifts to show a temperature different from the initial value. When a large temperature change occurs, the temperature detection element can no longer be used, or often requires calibration.

Assume that the ceramic substrate has a length of 10 mm and a width of 1 mm, that the resistance pattern width is 10 μm and the insulating distance width is 10 μm, and that the entire resistance is 1,000 Ω. In this case, 50 (10 μm×10 mm×50) linear portions of the resistance pattern line up in the widthwise direction of the ceramic substrate, and the resistance of each linear portion (10 mm) becomes 20 Ω. Hence, 50 linear portions are subjected to distortion caused by the difference in thermal expansion. The distortion caused by the difference in thermal expansion in the longitudinal direction is:

20 (resistance)×10 (length)×50 (number of linear portions)×z=10,000z (the unit is arbitrary)

where z is the distortion coefficient of the resistance of 20 Ω per unit length of 1 mm. A large distortion occurs in this manner, and a large resistance drift occurs due to the distortion. Furthermore, this distortion changes the temperature-resistance coefficient of the Ni foil resistor itself which is specific to its metal. When the temperature changes, the resistance becomes different from the temperature coefficient of the Ni foil resistor itself, causing a temperature error yet.

In contrast to this, when the Ni foil resistor is bent back in the widthwise direction of the ceramic substrate, the respective linear portions (each with a length of 1 mm) line up in the longitudinal direction of the ceramic substrate. The distortions of the respective linear portions appear as a distortion in its widthwise direction. In the ceramic substrate with the above ratio (10:1), the drift decreases to about 1/10 times. If the ceramic substrate has a length of 10 mm and a width of 1 mm, the number of linear resistance patterns each with a width of 10 μm and a length of 1 mm becomes 500. In this case, the distortion caused by the difference in thermal expansion in the widthwise direction is:

2 (resistance)×1 (length)×500 (number of linear resistance portions)×z=1,000z (the unit is arbitrary)

which is almost 1/10 that obtained when the Ni foil resistor is bent back in the longitudinal direction. In this manner, when the Ni foil resistor is bent back in the widthwise direction of the substrate, the distortion decreases considerably.

Also, since the distortion is small, the drift of the temperature-resistance coefficient of the Ni material itself decreases, and a high-precision temperature sensor with a small temperature error can be obtained.

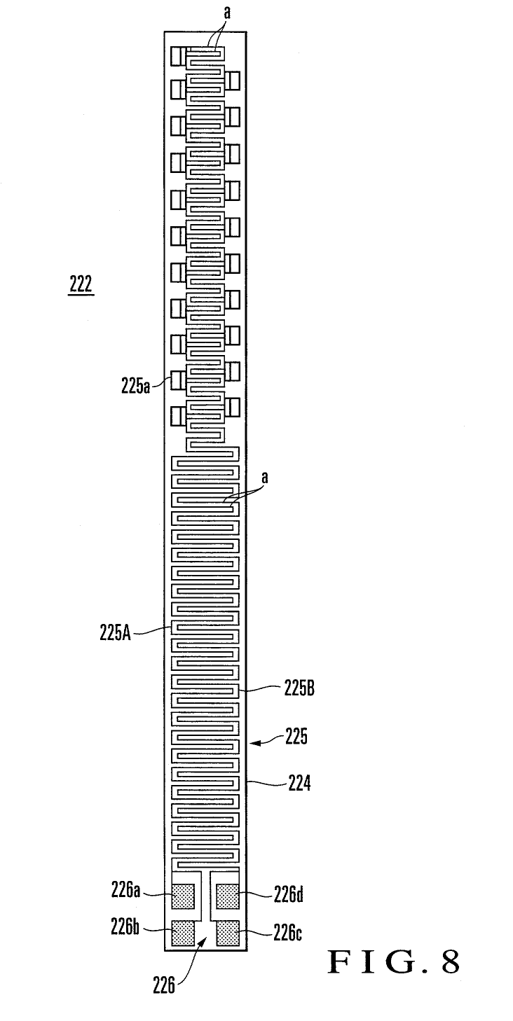

The second embodiment in which the Ni foil resistor is bent back in the widthwise direction of the substrate will be described with reference to FIG. 8.

As shown in FIG. 8, an Ni foil resistor 225 is formed such that its resistance pattern is bent back in the widthwise direction of a ceramic substrate 224. The Ni foil resistor 225 has a forward-path pattern 225A and backward-path pattern 225B which are bent back at the distal end of the ceramic substrate 224 and mesh with each other in a non-contact manner such that they are displaced from each other by a half pitch. The ceramic substrate 224 has, at its proximal end, a pad portion 226 comprised of a total of four pads 226a to 226d including two groups each having two pads, and a plurality of trimming resistance patterns 225a. When the resistance pattern is formed of the forward-path pattern 225A and backward-path pattern 225B in this manner, the forward- and backward-path patterns become equal, so the distortion can be decreased.

Linear portions a of the forward- and backward-path patterns 225A and 225B are parallel to the widthwise direction of the ceramic substrate 224 and line up at constant pitches in the longitudinal direction. The Ni foil resistor 225 has a thickness of ⅕ μm to 3 μm, a width of about 10 μm, and a resistance of about 1,000 Ω, and its surface is entirely covered with an insulating film.

The trimming resistance patterns 225a include several types with different resistances, e.g., 1 Ω, 2 Ω, and 3 Ω. The resistance patterns 225a are entirely electrically connected to the Ni foil resistor 225 when the Ni foil resistor 225 is formed by etching, and are disconnected when necessary in adjusting the resistance. More specifically, assuming that the resistance of the Ni foil resistor 225 is 995 Ω, this is smaller than the desired resistance of 1,000 Ω by 5 Ω. For this reason, one 1-Ω resistance pattern 225a and two 2-Ω resistance patterns 225a are disconnected so the 1,000-Ω Ni foil resistor 225 is obtained. In actual trimming, the resistance is adjusted by a smaller value.

The Ni foil resistor 225 is formed in the following manner. An Ni foil fabricated by rolling is bonded to the surface of the ceramic substrate 224 with an adhesive. The resultant structure is subjected to dry etching or wet etching to decrease its thickness. A mask pattern is transferred and exposed to the Ni foil by photolithography, and portions other than the pattern is dissolved and removed, thus forming the Ni foil resistor 225 easily. At this time, the pad portion 226 is formed simultaneously. In order to increase the strength, masking is performed, so the pad portion 226 is formed thicker than the Ni foil resistor 225. The thickness of the pad portion 226 is about 3 μm.

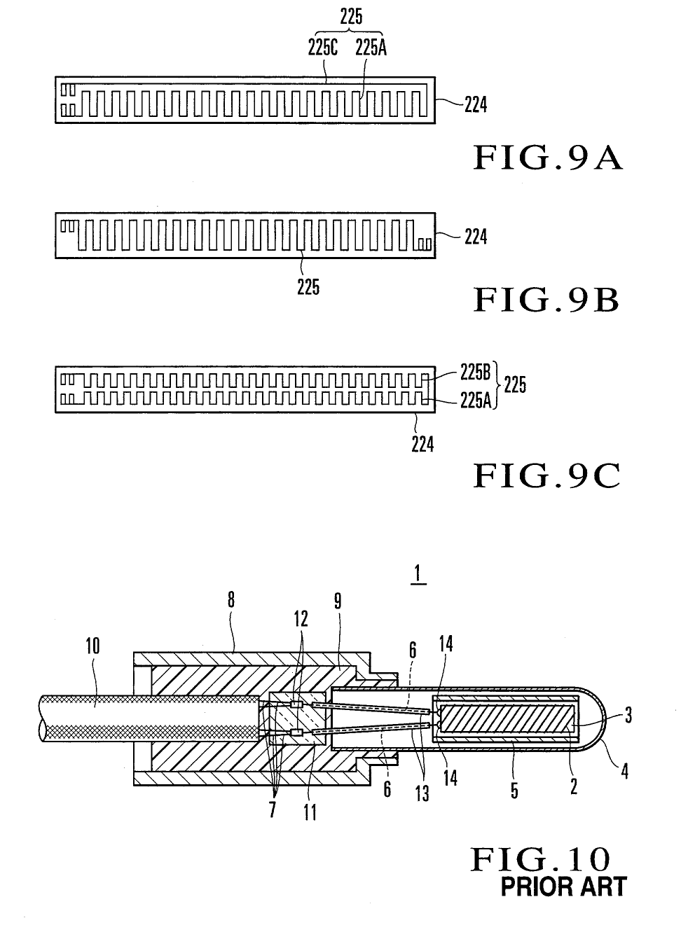

The pattern of the Ni foil resistor 225 is not limited to that shown in FIG. 8, but can be the patterns shown in FIGS. 9A to 9C. An Ni foil resistor 225 shown in FIG. 9A has a forward-path pattern 225A bent back in the widthwise direction of a ceramic substrate 224, and a linear backward-path pattern 225C extending in the longitudinal direction of the ceramic substrate 224. An Ni foil resistor 225 shown in FIG. 9B is bent back in the widthwise direction of a ceramic substrate 224, and its two ends are terminated at the two ends of the substrate. An Ni foil resistor 225 shown in FIG. 9C has axisymmetrical forward-path pattern 225A and backward-path pattern 225B each extending for half the width of a ceramic substrate 224 and bent back in the widthwise direction of the ceramic substrate 224.

Since the Ni foil resistor 225 shown in FIG. 9A has the linear backward-path pattern 225C extending in the longitudinal direction of the ceramic substrate 224, a distortion in the longitudinal direction occurs. However, as the number of linear portions is as small as one several hundredths that of the pattern (FIG. 2) bent back in the longitudinal direction of the ceramic substrate 224, no problem arises.

Since the Ni foil resistor 225 shown in FIG. 9B does not have a linear backward-path pattern 225C like that shown in FIG. 9A, the distortion can be further decreased. Since the linear portions can be formed in the entire width of the ceramic substrate 224, the pattern length can be increased, enabling downsizing.

In the Ni foil resistor 225 shown in FIG. 9C, since the forward- and backward-path patterns 225A and 225B form equal patterns, occurrence of the distortion can be decreased.

According to this embodiment, the Ni foil resistor 225 is bent back in the widthwise direction of the ceramic substrate 224. Even if the ratio of the length to the width of the ceramic substrate 224 is large, the temperature error is smaller than in a case wherein the Ni foil resistor 225 is bent back in the longitudinal direction of the substrate, and a sensor with high measurement precision can be obtained.

The conventional Pt resistance temperature sensor and the temperature sensor according to this embodiment will be compared.

The conventional Pt resistance temperature sensor has a resistance of 100 Ω. A measurement current of 1 mA to 2 mA is supplied to the conventional Pt resistance temperature sensor, and a temperature change output is obtained from the sensor. For example, when the current is 1 mA, the heat value (power consumption RI²) of the resistor is:

100×10⁻³×10⁻³=10⁻⁴ W=0.1 mW

When the TCR (Temperature Coefficient) of Pt is 3,850 ppm/° C., the sensitivity for 1° C. is:

100×3850×10⁻⁶×1×10⁻³=385 μV/° C.

As the sensitivity for 1 m° C. is 1/1,000 of that for 1° C., it is 0.385 μV/m° C.

In contrast to this, when an Ni foil resistor 225 with a resistance of 1,000 Ω and a TCR of 6,000 ppm/° C. is used, the resistance becomes ten times. To obtain the same sensitivity (temperature change output), the measurement current can be set to 0.064 mA, i.e., to 1/15.

0.385×10⁻⁶÷(1000×6000×10⁻⁶×10⁻³×10⁻³)=0.064 mA

The heat value (power consumption) of the Ni foil resistor 225 is:

1000×0.064×10⁻³×0.064×10⁻³=0.004×10⁻³ W

=0.004 mW

and is accordingly 1/25. When the resistance is increased, the power consumption can be decreased while maintaining the sensitivity. This is very effective when this temperature sensor is used in a semiconductor manufacturing apparatus that requires temperature control by 1 m° C.

In the embodiments described above, a ceramic substrate is used as the substrate for the temperature detection element. However, the present invention is not limited to this at all, and a substrate made of glass, silicon, a metal, or the like may be used.

In the above description, the Ni foil resistor is used as the metal foil resistor. However, a platinum foil resistor may be used. A platinum foil can be used up to a high temperature as it has a higher corrosion resistance than that of an Ni foil. Usually, an Ni foil can be used up to about 200° C. A platinum foil can be used up to a much higher temperature of 300° C. or more. As the TCR (temperature coefficient) of the temperature sensor using the platinum foil is the same as a standard platinum wire resistor temperature sensor defined by the JIS and the like, a temperature adjusting unit or the like can be designed easily.

As has been described above, according to the present invention, both downsizing of the sensor itself and an increase in resistance can be achieved simultaneously. Consequently, the power consumption is small, so the present invention is particularly suitable for temperature measurement in a semiconductor manufacturing apparatus or the like. Also, an Ni foil resistor can freely have a desired resistance when compared to a Pt wire resistor.

Since the 4-wire cable is employed, the voltage across the two ends of the Ni foil resistor can be measured, and measurement is not adversely affected by the resistances of external lead lines. Since a large resistance can be set for the resistor, highly precise temperature measurement with a small error can be performed, and the measurement precision of the sensor can be improved.

Since the Ni foil resistor and the flexible printed wiring board are bonded to each other by bump bonding or through bonding wires, bonding is easy and the reliability can be increased. Since the temperature detection element is urged against the inner wall surface of the protection pipe by utilizing the elasticity of the flexible printed wiring board, variations in temperature response are small, and the temperature detection element does not move upon application of a vibration or impact, and can maintain a stable resistance. Since the Ni foil resistor is covered with the flexible printed wiring board, the Ni foil resistor will not come into contact with the protection pipe to cause short circuit.

Entering water, humidity, or the like into the protection pipe can be reliably prevented, and the environmental resistance and reliability of the temperature sensor can be increased. Therefore, the resistance does not drift, and a stable performance is maintained over a long period of time, so the temperature can be detected with high precision. Since an inert gas or oil is sealed in the protection pipe, the stability and thermal conductivity of the Ni foil resistor can be increased. Particularly, when the inert gas or coil is sealed in a pressurized state, the response speed with respect to a temperature change can be further increased.

Since the pattern of the Ni foil resistor is bent back in the widthwise direction of the substrate, the distortion of the resistor becomes small, and the change over time of the TCR decreases. Thus, a high-precision temperature sensor can be obtained. When the Ni foil resistor is formed such that its forward- and backward-path patterns are equal, occurrence of the distortion can be decreased.

What is claimed is:

1. A temperature sensor comprising:
a temperature detection element having a temperature detection metal foil resistor;
a band-like flexible printed wiring board with said temperature detection element being attached to a distal end thereof; and
a thin, elongated protection pipe for accommodating said flexible printed wiring board and said temperature detection element.

2. A sensor according to claim 1, comprising a pair of current lines and a pair of signal detection lines connected to the metal foil resistor.

3. A sensor according to claim 1, wherein said temperature detection element is urged against an inner wall surface of said protection pipe by utilizing an elasticity of said flexible printed wiring board.

4. A sensor according to claim 1, wherein the metal foil resistor of said temperature detection element is bump-bonded to a circuit pattern of said flexible printed wiring board.

5. A sensor according to claim 1, wherein
the metal foil resistor of said temperature detection element is connected to a circuit pattern of said flexible printed wiring board through a bonding wire, and
a bonding portion of the metal foil resistor and the circuit pattern of said flexible printed wiring board is molded with a synthetic resin.

6. A sensor according to claim 1, wherein the metal foil resistor of said temperature detection element is covered by a distal end of said flexible printed wiring board.

7. A sensor according to claim 1, wherein said protection pipe has a small-diameter distal end which accommodates said temperature detection element, and a large-diameter proximal end with one end continuous to the distal end and the other end which is open.

8. A sensor according to claim 7, further comprising a hermetic component having a plurality of pin-like terminals for connecting said temperature detection element in said protection pipe and external lead lines to each other,
said hermetic component being pressed into an opening of said protection pipe, thereby sealing said protection pipe.

9. A sensor according to claim 8, wherein one of an inert gas and oil is sealed in said protection pipe.

10. A sensor according to claim 1, wherein the metal foil resistor comprises an Ni foil resistor.

11. A sensor according to claim 1, wherein the metal foil resistor comprises a platinum foil resistor.

12. A sensor according to claim 1, wherein said temperature detection element has an elongated substrate with a surface where the metal foil resistor is formed, and
the metal foil resistor has a resistance pattern repeatedly bent back in a longitudinal direction of the substrate.

13. A sensor according to claim 1, wherein
said temperature detection element has an elongated substrate with a surface where the metal foil resistor is formed, and
the metal foil resistor has a resistance pattern repeatedly bent back in a widthwise direction of the substrate.

14. A sensor according to claim 13, wherein the resistance pattern has a forward-path pattern and backward-path pattern which are bent back at one end in a longitudinal direction of the substrate.

15. A sensor according to claim 14, wherein the forward-path pattern is formed to be repeatedly bent back in the widthwise direction of the substrate, and the backward-path pattern is linearly formed in the longitudinal direction of the substrate.

16. A sensor according to claim 14, wherein the forward- and backward-path patterns are formed to be repeatedly bent back in the widthwise direction to each extend for half a width of the substrate.

17. A sensor according to claim 14, wherein the forward- and backward-path patterns are formed to mesh with each other in a non-contact manner so as to be displaced from each other by a half pitch.
